(19) United States
(12) Patent Application Publication
(10) Pub. No.: US 2007/0136326 A1
(43) Pub. Date: Jun. 14, 2007

(54) Apparatus and method for defining relationships between component objects in a business intelligence system

(75) Inventors: Gregory John McClement, Maple Ridge (CA); Carlos Antonio Mejia, Vancouver (CA)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A. Levallois-Perret (FR)

(21) Appl. No.: 11/304,980

(22) Filed: Dec. 14, 2005

(51) Int. Cl. G06F 7/00

(52) U.S. Cl. 707/100

(57) ABSTRACT

A computer readable memory includes a first data structure storing information characterizing a parent component object, a child component object, and a relationship object. The parent component object, the child component object, and the relationship object are associated to form a record of an edge in a graph that characterizes a business intelligence system. Executable instructions apply rules to the graph to alter the operation of the business intelligence system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BRIEF DESCRIPTION OF THE INVENTION

This invention relates generally to information processing. More particularly, this invention relates to an apparatus and method for creating and manipulating relationships between business objects in business intelligence systems.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

A subset of business intelligence tools are report generation tools. There are a number of commercially available products to produce reports from stored data. For instance, Business Objects Americas of San Jose, Calif., sells a number of widely used report generation products, including Crystal Reports™, Business Objects OLAP Intelligence™, and Business Objects Web Intelligence™, and Business Objects Enterprise™. As used herein, the term report refers to information automatically retrieved (i.e., in response to computer executable instructions) from a data source (e.g., a database, a data warehouse, and the like), where the information is structured in accordance with a report schema that specifies the form in which the information should be presented. A non-report is an electronic document that is constructed without the automatic retrieval (i.e., in response to computer executable instructions) of information from a data source. Examples of non-report electronic documents include typical business application documents, such as a word processor document, a spreadsheet document, a presentation document, and the like.

A universe is an interface to a database or a set of databases. A universe enables an end user to build a query without having to understand details of the database. Thus, universes isolate users from the complexities of the database structure as well as the intricacies of SQL syntax. A universe can represent any specific application, system, or group of users. For example, a universe can relate to a department in a company, e.g., marketing or accounting.

A database is a set of related files collected for information storage and processing purposes that is managed by a database management system. A database may include a data warehouse, which is a form of data storage utilized in business intelligence systems. A data warehouse integrates operational data from various parts of an organization, e.g., sales, customer, marketing and inventory data.

In known business intelligence tools, e.g., report generation tools, and other software, knowledge about which component objects are related is of importance to the system. This knowledge must be updated as both relationships and component objects are added, modified, or deleted. These requirements create a data structure problem. A solution in the prior art is to store in each component object information about the component object's relationships with other component objects. In this solution, each component object contains a reference to its related component object(s). For example, in FIG. 1 a component object 110 contains an object reference 112 that refers (e.g., names, address references, or points) to component object 120. In the illustrated example, the Sales Report object 110 contains an object reference to the Sales Universe. Likewise, component object 120 may refer to another component object, e.g., the appropriate database. If cycles are permitted component object 120 may contain a piece of data 122 that refers to component object 110. Herein the term object may replace component object.

Using a component object to store component object relationships has drawbacks including, when a component object is deleted, knowledge of relationships of component objects can be lost. For example if a child is deleted a parent object may still contain a reference to the child. In addition, some modifications of objects lead to loss of knowledge of relationships. Upon deletion or modification, this knowledge can be partially ensured by having supplemental reverse references (not shown), and by following forward and reverse references to other component objects upon deletion or modification of an object. Following references can be slow, as each component object must be accessed and each stored reference followed. The use of forward and reverse references creates duplicated information that resides in two places and must be simultaneously modified, created or deleted.

In known business intelligence tools only certain component objects may be related. Allowed relationships may have further constraints. The allowed relationships, and relationship constraints, can be codified in a set of rules. In the prior art, previous business intelligence tools have hard coded the rules into the program. Therefore, it is difficult to modify the rules.

In view of the foregoing, it would be highly desirable to provide improved business intelligence tools to overcome some of the limitations associated with existing business intelligence tools vis-à-vis managing the relationships between component objects.

### SUMMARY OF THE INVENTION

The invention includes a computer readable memory with a first data structure storing information characterizing a parent component object, a child component object, and a relationship object. The parent component object, the child component object, and the relationship object are associated to form a record of an edge in a graph that characterizes a business intelligence system. Executable instructions apply rules to the graph to alter the operation of the business intelligence system.

### BRIEF DESCRIPTION OF THE DRAWINGS

The invention is more fully appreciated in connection with the following detailed description taken in conjunction with the accompanying drawings, in which:

FIG. 1 illustrates a relationship structure from the prior art.

FIGS. 2A and 2B illustrate examples of graphs that may be utilized in accordance with embodiments of the invention.

FIGS. 3A, 3B and 3C illustrate data structures that may be utilized in accordance with embodiments of the invention.

FIGS. 4A and 4B illustrate data structures that may be utilized in accordance with embodiments of the invention.

FIG. 5 illustrates a system operated in accordance with an embodiment of the invention.

FIGS. 6A, 6B and 6C illustrate processing operations associated with an embodiment of the invention.

FIGS. 7A and 7B illustrate a series of examples of component object relationships that may be utilized in accordance with embodiments of the invention.

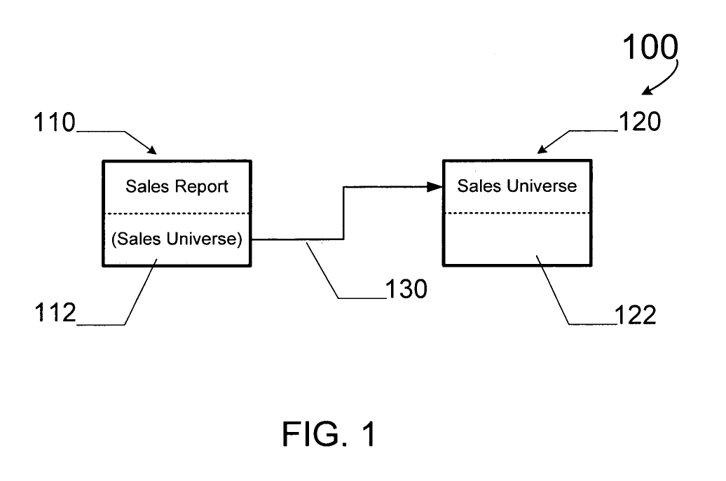

Like reference numerals refer to corresponding parts throughout the several views of the drawings.

### DETAILED DESCRIPTION OF THE INVENTION

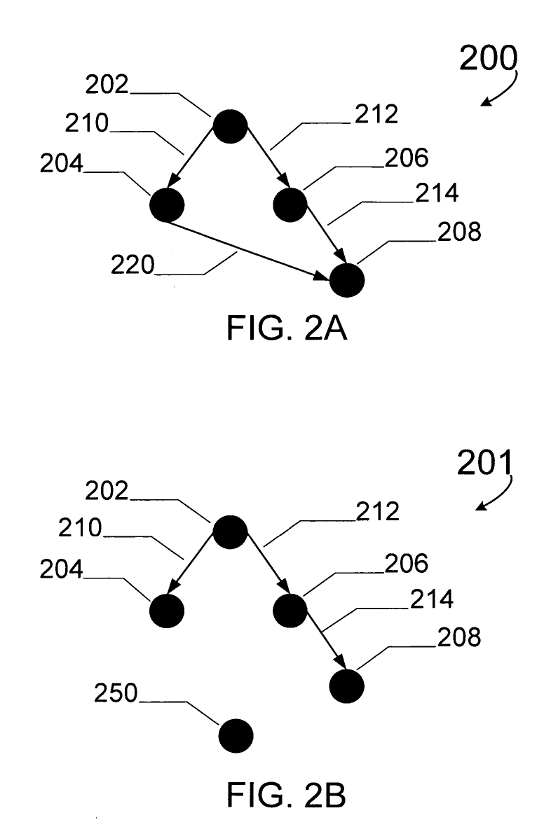

Embodiments of the present invention use graphs. A graph is a visual scheme that depicts relationships. FIG. 2A illustrates a type of graph commonly referred to as a directed acyclic graph 200. A graph may be defined by its vertices (e.g., 202, 204, 206, and 206, collectively denoted V), and its edges (e.g., 210, 212, 214, and 220, collectively denoted E). A graph G is then defined as G=(V, E). An individual vertex is labeled by its name and an individual edge is labeled by its name, e.g., 220, or the vertices at its termini, e.g., (204, 208). Graph 200 is a directed graph because the edges are defined with a direction. For example, edge (202, 206) is not the same as edge (206, 202). This can be denoted with arrows as edges, e.g., edge 212 of FIG. 2A. Graph 200 is considered connected because all vertices are coupled through direct connections or indirect connections. In embodiments of the present invention the graphs being manipulated are connected or unconnected. The graph 200 is acyclic, no traversal (along the direction indicated by arrows) of the graph returns to the starting point.

FIG. 2B illustrates another graph. Graph 201 is a special case of a directed acyclic graph called a tree. In a tree each vertex has only one parent. A vertex at the beginning of a directed edge is a parent, and the vertex at the end is a child. Graph 201 differs from graph 200 by the absence of an edge, e.g., 220, that gave one vertex (i.e., 208) two parents. In an embodiment of the present invention a graph is a directed acyclic graph. In an embodiment of the present invention a graph is a tree. Graph 201, is not connected because vertex 250 is not coupled to remaining elements of graph 201.

In accordance with embodiments of the present invention, a business intelligence tool stores and manipulates graphs. These graphs are used to define the relationships (e.g., associations and hierarchies) of component objects within the business intelligence tool. For example, a business intelligence tool may have user objects that belong to user group objects and the business intelligence tool must manage their relationship. In an embodiment of the present invention the relationships between a user and user group objects are managed by abstracting these objects as vertices and edges in a graph.

In accordance with an embodiment of the invention, component objects and relationships are modeled as graphs. For example, graph vertices are the component objects in the business intelligence system. The various relationships may be described in relationship objects, also referred to as relationship component objects. These relationship objects may contain data that encodes rules for the relationship. Information on edges is typically not stored in the component objects (e.g., the vertices). Rather, it is calculated dynamically. The edges are determined by searching the data structure comprising the name of the terminal objects and the name of the relationship. These queries return the data on edges as if the data was stored with the vertices. The data structures and operations presented are widely applicable to many kind of component objects. The types of relationships are expandable.

Embodiments of the present invention manage a number of different types of component objects and relations. A set of objects that a business intelligence system may manage are documents (including reports), universes and databases. A document is associated with a universe or a database. A universe is associated with documents and a database. One relationship object may define how documents, universes, and databases are associated or there may be one relationship for each pair of component object types.

Files and folders are another example of objects and relations. In an embodiment of the present invention a file and folder hierarchy is a tree. In one embodiment, one relationship object defines the relationship between folder and folder, and another defines the relationship between folder and file. In another embodiment, one relationship object defines both types of relationships.

Embodiments of the present invention combine data structures to store graphs in accordance with various aspects of the present invention. In one embodiment of the present invention, a table is combined with a set to model a graph. In another embodiment, a series of tables are combined with one or more sets to model a graph. In another embodiment, one or more matrices are combined with one or more sets to model a graph. In another embodiment, one or more cubes are combined with one or more sets to model a graph. These combined data structures can model a graph, manage relationships between component objects, or perform other operations in accordance with aspects of the present invention.

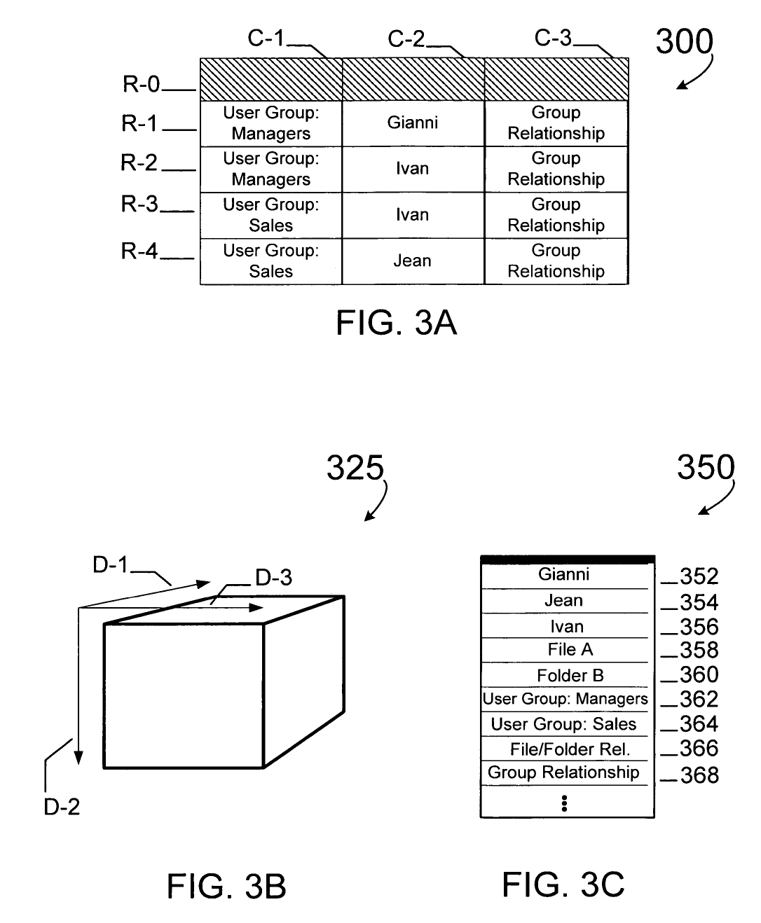

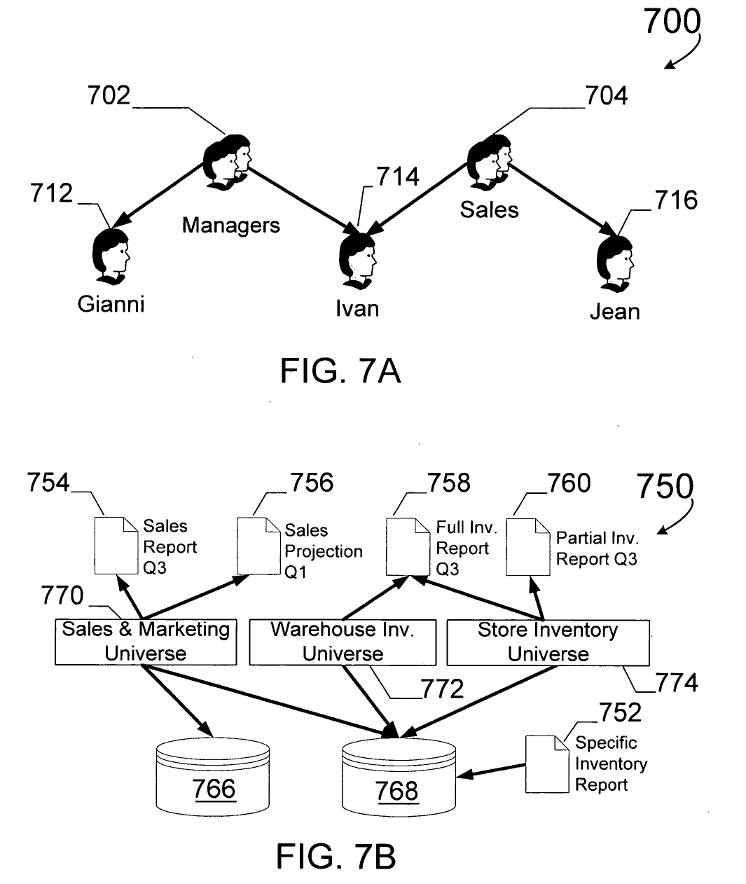

FIG. 3A illustrates a data structure associated with an embodiment of the invention. A table 300 is shown with rows (e.g., R-0, R-1, etc.) and columns (e.g., C-1, C-2, etc.). The number of rows and columns varies with embodiments of the present invention. Table 300 can be a table in a database, e.g., a relational database. Table 300 can be used to represent a graph such as graph 200 of FIG. 2A. The table 300 has a header row R-0. The cells in the header row define the content of each column. Alternately, the table 300 has no header row or the information that would be stored in the header row is stored elsewhere. In an embodiment of the invention, header row R-0 defines the contents of each column C-1, C-2, and C-3 as component object IDs within a business intelligence system. For example, row R-1, has the name of a user group in C-1. The name of a user is stored in C-2. The name of the appropriate relationship is stored in C-3. Rows R-1 through R-4 record the user/user group structure shown in FIG. 7A. In particular, Gianni is a member of a Managers group, Ivan is a member of both Managers and Sales groups, while Jean is a member of a Sales group. In FIG. 3A, the component objects are referred to by name for clarity. In an embodiment of the present invention component object IDs are used to identify component objects.

In one embodiment of the present invention, updates to the relationships between component objects are atomic because the information resides in one location, e.g., table 300. Loss of information about relations can be avoided my making all instructions that access or mutate a sensitive data structure (i.e., a table) critical sections of the instructions. These critical sections execute exclusively. Critical sections of instructions read or write to data that can be modified by another set of instructions or another instance of a set of instructions. Exclusivity of execution can be ensured by software tools, e.g., semaphores, monitors, condition variables, or hardware tools, e.g., interrupt masks.

In an embodiment of the present invention, a graph representing relationships between component objects can be modeled with a matrix. The matrix comprises rows and columns labeled by graph vertices. A relationship object ID for two adjacent vertices is stored in a cell. For a simple graph with no self-loops an adjacency matrix has no entry on its diagonal. For an undirected graph, the adjacency matrix is symmetric and only half of the matrix needs storing. For graphs with a large number of vertices, and few edges, the matrix may have a sparse structure and the matrix data structure can be designed to exploit the sparsity. A matrix differs from a table in that a table has Θ(1)×Θ(m) cells and entries where m=∥E∥ the number of edges in the graph. A matrix has Θ(n)×Θ(n) cells and Θ(m) entries, where n=∥V∥ the number of vertices in the graph. A function ƒ is big theta of function g (i.e., ƒ=Θ(g)) if the function ƒ is more or less the same as g. Formally, ƒ(n) is Θ(g(n)) if and only if there exists positive real constants c₁ and c₂ and a positive integer n₀ such that c₁g(n)≦ƒ(n)≦c₂g(n) for n greater than n₀.

In one embodiment of the present invention, multiple arrays or tables are used. Multiple arrays or tables could be used to improve performance or to reflect discontinuities within an underlying graph. In one embodiment, multiple tables are used to increase the performance of the business intelligence system.

In an embodiment of the present invention, a graph of component objects can be modeled in part by a cube 325, as shown in FIG. 3B. The cube 325 is a hypercube or a tabular data structure (e.g., table) of 3 or more dimensions. The cube 325 of FIG. 3B is limited to three dimensions for visualization purposes. The cube 325 has as a first dimension D-1 the graph semantics of the component object ID being stored therein (e.g., parent, child, relationship, which is similar to the columns of table 300 as defined by header row R-0). Another dimension of the cube D-2 is the natural number of relationship being stored by the cube (similar to rows of table 300). The third dimension is D-3. In one embodiment, the third dimension specifies a type of relationship or type of component object. For example, all edges involving users can be stored on one slice of the cube, while all edges involving reports could be stored on a separate slice.

FIG. 3C illustrates a data structure associated with an embodiment of the invention. FIG. 3C illustrates a set 350 in which each component object in the set is unique (can only appear once). In an embodiment where the component objects in set 350 are component objects, e.g., 352-368, each component object is identified by a component object ID (not shown). FIG. 3C, shows three user objects Gianni, Ivan and Jean, respectively as component objects 352, 354 and 356. The user groups these user objects belong to are Managers 362 and Sales 364. The relationship that links these users and user groups is shown as component object 368. A relationship between files and folders is shown as component object 366. File A 358 and Folder B 360 are stored in 350. The relationship that links these component objects is also included as a file/folder relationship 366. The relationship between File A and Folder B is not an edge in a graph unless it has an entry in a data structure that stores edge data, e.g., table 300, an array, cube 325. In an embodiment of the present invention a set or a plurality of sets are used to store component objects. In an embodiment of the present invention the set is implemented by another data structure, e.g., a heap or a Fibonacci heap.

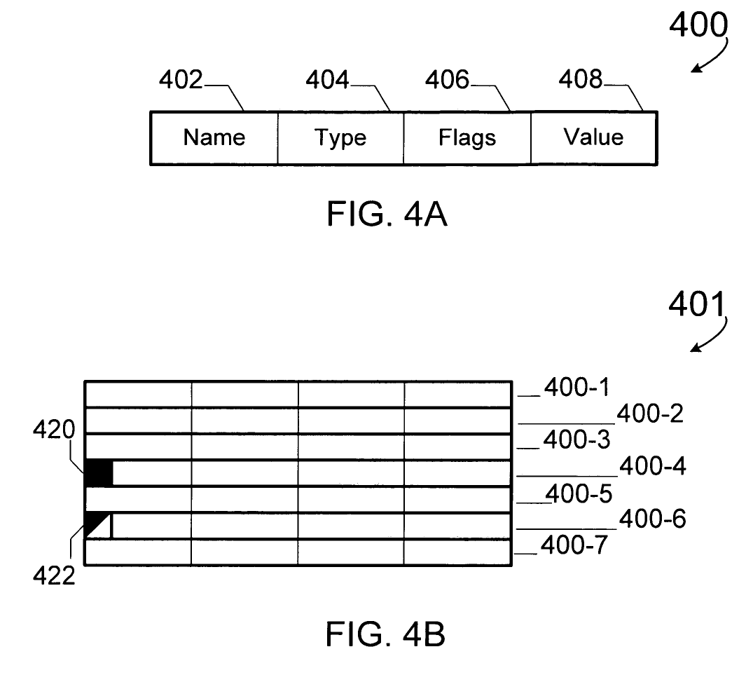

FIG. 4A illustrates an example of a data structures that stores metadata for component objects in accordance with an embodiment of the invention. In FIG. 4A, the data structure is a property 400 comprising data labeled name 402, type 404, flags 406, and value 408. The name 402 is the name of the property, e.g., a string or an integer. The type 404 is the type of the property, e.g., Boolean, date, double, integer, long integer, string, pointer, and property bag. The flag 406 is a marker, often in the form of an integer. The value 408 is the data associated with the type declaration. In the case of a property bag (e.g., a collection of properties) the value is another property. The property stores data about the component object. In other words, the property is metadata (data on data) on the component object. In the case of large amounts of data or metadata a property bag can be used.

The metadata on component objects may be hierarchical. The hierarchy of component objects and metadata can be collectively referred to as graphs. An example of the hierarchy of metadata when the metadata is stored in properties is shown in FIG. 4B. The following data structures are properties 400-1, 400-2, 400-4, 400-5, 400-6, and 400-7. 400-3 is a property bag containing properties 400-4, 400-5, and 400-6. The contents of the property bag are demarked by a start marker 420 and a stop marker 422. The hierarchy 401 of properties and property bags is a tree. In another embodiment of the present invention the hierarchy is a directed acyclic graph. In this example, the value 408 is a pointer to a property bag.

Property bags can be implemented in many ways. These include text based implementations, such as, a text file and a markup language, e.g., SGML, or XML. One implementation, that uses extensible markup language (XML), is show below. This XML code is metadata for a component object presented as a series of properties and property bags.

An example of a relationship object's metadata, implemented via properties in XML, is shown below as a listing with lines AA through AU.

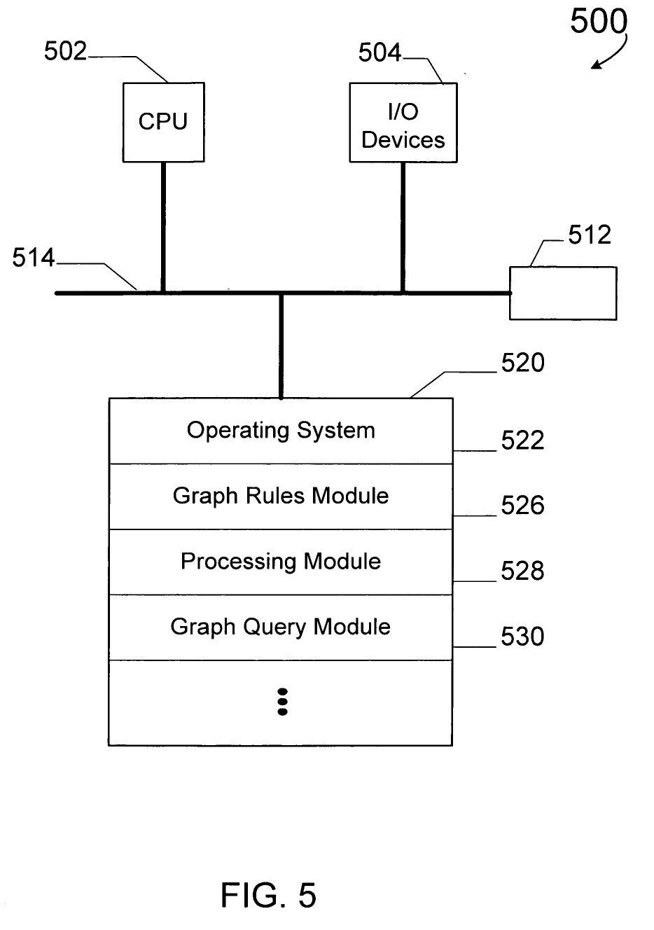

The given listing has no specific order although one could be imposed. Lines AA and AB are header material. Line AC opens a property bag containing the properties of the following lines. Line AC declares the component object as an object of a BI Tool. Line AD names the relationship being defined “Category-Document”. Lines AE-AG are meta data directed, assigning values to the properties named. Line AH defines a constraint rule, specifically the link type (see FIG. 5). Lines AI-AK define graph rules. Lines AL-AO define security rules. Line AP defines the name of the table that will record edges of the Category-Document relationship. Further metadata is defined in lines AQ and AR. The XML format allows as many properties to be added as needed. The property bags opened on lines AC and AR are closed on lines AS and AT.

```
AA)  <?xml version=“1.0” encoding=“utf-8” ?>
AB)  <plugin xmlns=“http://www.businessobjects.com/BusinessObjects_pin.xsd”>
AC)  <propertybag name=“CrystalEnterprise.Relation.Category” type=“Infoobject”>
AD)  <property name=“SI_NAME” type=“String” >Category-Document</property>
AE)  <property name=“SI_PARENTID” type=“Long” >46</property>
AF)  <property name=“SI_CUID” type=“String” >Ad_M6fwxd5hA.DP0TSjnc</property>
AG)  <property name=“SI_SYSTEM_OBJECT” type=“Bool”>true</property>
AH)  <property name=“SI_RELATION_LINK_TYPE” type=“String” >Soft</property>
AI)  <property name=“SI_RELATION_IS_A_DAG” type=“Bool” >true</property>
AJ)  <property name=“SI_RELATION_IS_A_TREE” type=“Bool” >false</property>
AK)  <property name=“SI_RELATION_CONNECTED” type=“Bool” >false</property>
AL)  <property name=“SI_RELATION_ADD_CHILD_RIGHT” type=“Long” >3</property>
AM)  <property name=“SI_RELATION_REMOVE_CHILD_RIGHT” type=“Long”
                                                                            >3</property>
AN)  <property name=“SI_RELATION_ADD_PARENT_RIGHT” type=“Long” >6</property>
AO)  <property name=“SI_RELATION_REMOVE_PARENT_RIGHT” type=“Long”
                                                                            >6</property>
AP)  <property name=“SI_RELATION_TABLE_NAME” type=“String”
                                                            >RELATIONS</property>
AQ)  <propertybag name=“SI_RELATION_DYNAMIC_PROPERTIES” type=“Array” >
AR)  <property name=“SI_TOTAL” type=“Long” >3</property>
              . . .
AS)  </propertybag>
AT)  </propertybag>
AU)  </plugin>
```

© Business Objects, 2003-2005. All rights reserved. (117 U.S.C. § 401)

FIG. 5 illustrates a system 500 that is operated in accordance with one embodiment of the present invention. System 500 may be a digital computer or functionally equivalent device that comprises a CPU 502, a set of input and output devices 504, a system memory 520, a network interface circuit 512 or other communication circuitry, and an internal bus 504 for interconnecting the elements of the system 500. The network interface circuit 512 provides connectivity to a network (not shown), thereby allowing the system 500 to operate in a networked environment. The system memory 520 may be random-access memory (RAM). The system memory 520 may also include read-only memory (ROM). The system memory may be divided into parts including a volatile part and a non-volatile part. The volatile part could be for storing system programs and programs loaded from the non-volatile part. A controller could transfer data between the volatile part and the non-volatile part. The set of input and output devices 504 may include one or more input device (e.g., mouse, keyboard, touch screen, serial port, microphone) and one or more output device (e.g., display, printer, speaker). There may be more than one CPU.

The system memory 520 stores executable instructions to implement operations of the invention. These are stored as modules. The modules stored in system memory 520 are exemplary. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

In one embodiment, s ystem memory 520 also stores an operating system module 522. The operating system module 522 may include instructions for handling various system services, such as file services or for performing hardware dependant tasks. Many operating systems that can serve as operating system module 522 are known in the art. In some embodiments, no operating system is present and instructions are executed sequentially on a non-threaded machine. In some embodiments, system memory 620 includes a software platform acting as an operating system. Examples of software platforms include, but are not limited to, BusinessObjects Enterprise XI™, and BusinessObjects Enterprise XI™ Release 2, both by Business Objects SA, Paris, France, and Business Objects Americas Inc., San Jose, Calif., U.S.A.

A business intelligence tool, e.g., report generation tools, query tools, and analysis tools, may run on a software platform designed for business intelligence. Indeed a business intelligence platform could support an entire range of BI tools including reporting, query, analysis, and performance management tools. The business intelligence platform also provides support for features like user management (e.g., login), file management, and security. The business intelligence platform may provide additional features such as, a database query engine, semantic layer tools, data integration tools, and OLAP tools. A business intelligence platform could provide features normally associated with an operating system. The operating system module 522 may operate in conjunction with modules described below.

In one embodiment, the executable instructions include a graph rules module 526. The graph rules module 526 ensures that the graphs created or manipulated by system 500 are valid, e.g., conform to a given set of rules. The graph rules module 526 may include instructions for searching for a set of graph rules, for checking a set of graph rules (e.g., check against a formal grammar specifying rules, check version of rules), or for loading a set of graph rules. The graph rules module 526 may include instructions for allowing a user to define a new rule or set of rules. The graph rules module 526 may include instructions for enforcing rules. Graph rules module 526 could enforce rules by parsing rules as defined by metadata stored in component objects, e.g., properties. In addition to being defined by a data source, e.g., metadata or properties accessed by the instructions in module 526, graph rules can be hard coded in the instructions of module 526. Graph rules module 526 may enforce graph characteristic, constraints, security, or other rules.

The characteristic rules control the shape and behavior of the graph. Some characteristic rules control how deletes are cascaded through the graph. For example, a relationship object defining a relationship may have a link property. The link property affects how a delete or modification operation is propagated through the graph. A possible link type is “soft” when a parent vertex has deleted descendent vertices that are not automatically deleted. Another possible link types is “hard” when a parent vertex has deleted descendent vertices. The effect on decedents could be hard coded or defined in another property of the relationship object. For example, deletes could be cascaded or prevented. Other graph characteristic rules include a rule for enforcing a particular graph type. For example, a relationship object defining a relationship may have as a property the Boolean value, such as, GRAPH_IS_DAG, GRAPH_IS_TREE or GRAPH_IS_CONNECTED. If one of these is true, then a modification of the graph that creates a graph that is not a direct acyclic graph, tree, or connected graph, respectively will fail. Other characteristic rules are possible.

The constraint rules control which objects are allowed in the graphs. Constraint properties are checked before edges are created or modified. Only objects meeting the specified conditions are allowed to become nodes in the graph. In an embodiment of the present invention the constraint rules specify directionality. That is, which objects are parents and which are children. The constraint rules can specify which objects can participate in a given relationship. Restrictions can be on the allowed parents, children, both, or more complicated restrictions. The constraint rules can specify if an object can have terminal node children or non-terminal node children. Non-terminal nodes may contain children themselves, whereas terminal nodes may not. In an embodiment, if an object contains children itself it can only be added as a child non-terminal node. In an embodiment, constraint rules are checked before edges are created or modified. Only objects meeting the specified conditions are allowed to become nodes in the graph. Other constraint rules are possible.

Security rules define the rights a user must have in order to add or delete edges in a graph. Security rules can include the rights needed to add or delete child vertices. Security rules can include the rights needed to add or delete parent vertices. Security rules can include rules such as who can view various data associated with a vertex or rights needed on both component objects to create a relationship.

Edge copy rules define if and how an edge is copied if a vertex upon which the edge is incident is copied. In an embodiment of the present invention edges are not copied along with an object by default. In an embodiment, an object can have edge copy properties. The edge copy rules can provide data to graph rules module 526 rules module indicating that the system 500 should copy the edge along with the object. An edge is defined by an entry in the data structure listing the parent, child, and relationship, e.g., table 300 or cube 325.

The rules included in module 526 may include rules for prescribing if and how a vertex in a graph can be deleted, e.g., delete possible without modification of other vertices, delete possible without deletion of other vertices, deleting a parent has ramifications on children or ancestors. Rules in the event of modification of a vertex may also be used. These rules may share similarity to the rules for deletion. The rules included in module 526 may include rules for prescribing if and how a vertex in a graph can inherit from its ancestor.

Table 1 lists a series of component object relationships. These relationships are exemplary and non-limiting, as other relationships are possible.

TABLE 1

| | |
|---|---|
| User | User group |
| Document | Category |
| Universe | Data Connection |
| Category | Universe |
| Universe | Universe |
| Report | Business View |
| Report | Document |
| Report | Database |
| Databases | Metadata Layer |
| Metadata Layer | Report |
| Server | Server Group |

In one embodiment, the executable instructions include a processing module 528. The processing module 528 allows system 500 to update graphs. For example, a user may want to create a relationship, add an edge corresponding to a relationship, delete an edge, update a relationship, copy an edge, or add, delete or modify a vertex. In an embodiment of the present invention, module 528 includes instructions for defining a component object which defines a relationship.

A relationship is a set of data and a set rules defining an object with respect to various behaviors, e.g., characteristic, constraint, security and edge copy behaviors as defined by rules. A relationship is defined in a relationship object. One relationship object exists for each kind of relationship. A user creates a relationship by defining a set of properties, such as discussed in relation to FIG. 4. The processing module 528 allows system 500 to add edges to graphs and define relationships.

In one embodiment, the executable instructions include a graph query module 530. The graph query module 530 allows system to 500 to query data relations modeled by graphs. For example, a user may want to retrieve component objects subject to specified criteria, e.g., retrieving ancestors, parents, children, descendents, siblings, orphans, connected components or combinations thereof. Given the relationships between component objects and amongst pieces of metadata are modeled by graphs, nearly any conceivable graph algorithm may be included in instructions in module 530. The graph query module 530 may traverse the graph according to variable and definable criteria in order to select a vertex. The graph query module 530 may search the graphs in embodiments of the present invention. In another embodiment, the relationship query module 530 performs a breadth first search of the graph.

The graph query module 530 allows the system to store edge data in a central data structure, but present the edge data as being part of a vertex object. A query to find an edge involves searching the data structure listing the parent, child, and relationship, e.g., table 300 or cube 325. If the target of the query is a list of vertices joined by an edge to a specified vertex, then module 528 can return the list of adjacent vertices as property of the specified vertex. For example, in the context of the relationship been data connections and universes, the relationship defines a data connection as the parent and the universe as the child. The universe object has a property ID of its parents. This means that if the parent of the universe is requested the ID of the parent (the data connection) object will be placed into the child object (the universe). The ID can be placed in a property bag called SI_DATACONNECTION. If a user through module 528 queries all properties of the universe object, the property bag called SI_DATACONNECTION that contains the ID of at least one data connection is returned. That ID is calculated dynamically. In an embodiment, a list of IDs is dynamically generated and returned as if the list was a property in the component object.

The graph query module 530 may be configured to combine relationship queries, nested queries, or connected component queries. The queries can be performed with a function of the form NAME(RELATIONSHIP, START VERTEX). The returned result is a component object ID or a list of component object IDs. The graph query module 530 allows the system to store edge data for many different relationships but have these relationships searchable as if they were all of the same type, by combining relationships. For example, a user can own a folder and the folder could own a file. The relationship between user and folder, and folder and file are different. However, through module 530 a query can be made to find all the decedents of the user, along any edges with the user folder/relationship or folder/file relationship. For example, an instruction may include a call to a function of the form “DECENDENTS(‘user/folder’OR ‘folder/file’, ‘username’)”. This query can be logically combined with an expression to filter for files only, e.g., “AND WHERE SI_TYPE=‘File’”. The graph query module 530 allows the system to perform nested queries. For example, a data connection is the parent of a universe, and the universe is the parent of a report. The data connection/universe relationship is different from the universe/report relationship. A user, or system 500, may want to know which data connection a report needs. This can be done by a nested query. For example, an instruction may include a call to a function of the form “PARENTS(‘data connection/universe’, PARENTS(‘universe/report’, ‘report_name’))”. The graph query module 530 allows the system to makes quires of all connected components. For example, system 500 may need to migrate all component objects in FIG. 7B but not those in FIG. 7A. Graph query module 530 can do this by taking a list of relationships (e.g., all relationships known to the system) and a component object in a graph that is to be migrated, e.g., database 766. The query can return all the objects that are coupled to the starting vertex—in this example, all components in the hierarchy of databases, metadata layers, and documents 750.

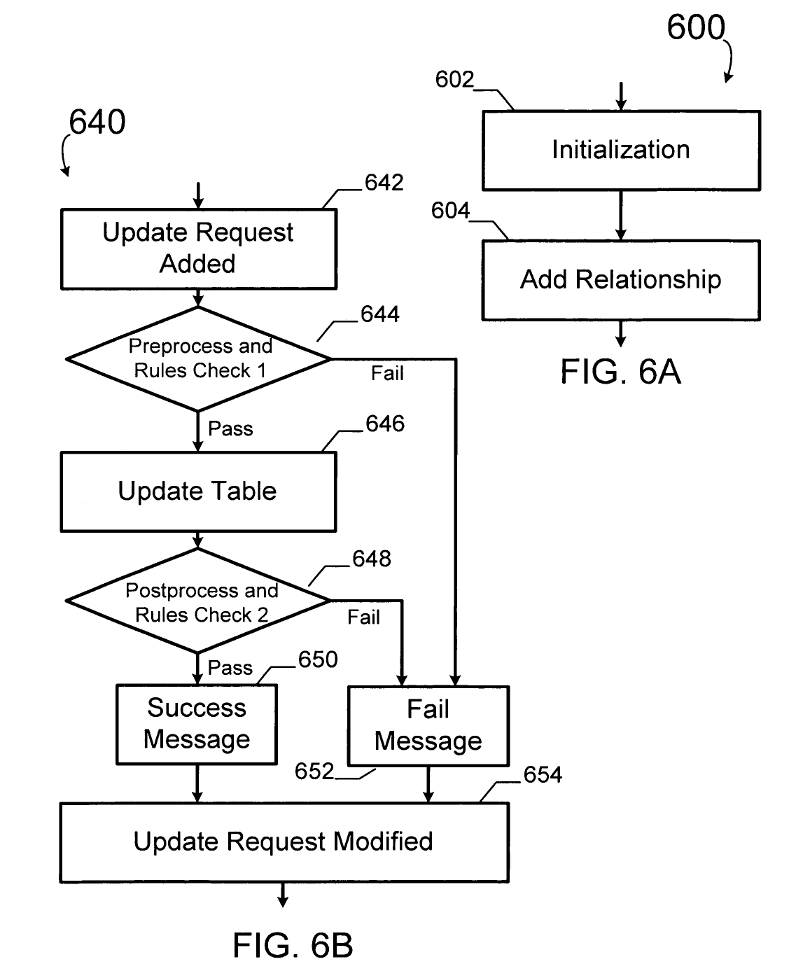

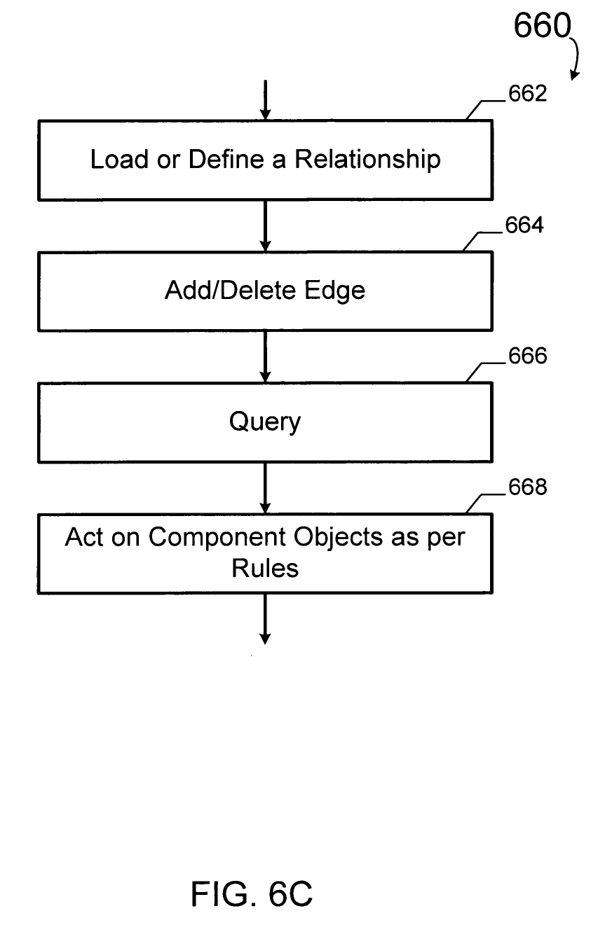

FIGS. 6A, 6B, and 6C illustrate processing operations associated with embodiments of the invention. A set of optional operations 600 for defining a relationship is shown in FIG. 6A. In operation 602 a system initializes by initializing its default and existing relationships. Operation 602 may include initializing those relationships hard coded into the system. Hard coded includes defined by computer code or by circuits. Operation 602 may include initializing those relationships previously defined. In operation 604 a component object is defined by a user. Metadata can be added to the component object by the user. The metadata can include definitions for constraint, graph, security, and edge copy rules. The component object's metadata should conform to the format or schema of a relationship object. The component object is saved as a relationship object. In this case, no edges of the type defined by the new relationship object would exist.

FIG. 6B illustrates operations for adding or deleting an edge in a graph. The set of operations 640 cover addition and deletion, however, only addition will be described in full. In operation 642 a component object has an update request added to its metadata. The update proposes the addition of an edge. For example, a user may add a report Sales Projection Ql to a universe, Sales Universe. The ID of the parent object is added (temporarily) to the child object (Sales Projection Ql), or vice versa. The Sales Projection Ql object is then flagged for graph update, e.g., the component object could have an ADD_PARENTS property. If pre-processing and a rules check is required

Preprocessing operation 644 may include enforcing constraint and security rules. In an embodiment of the present invention the constraint rules are directed to the proposed edge. In an embodiment of the present invention the security rules include verifying the user has the rights to add an edge. If the appropriate security and constraint rules are not satisfied (644—Fail) then a fail message is generated 652. Otherwise (644—Pass), a data structure, e.g., table, array or cube, that stores edges is updated 646. In an embodiment, the data structure is a table updated in batches. Batch processing can improve performance. In operation 648, post processing, such as the addition of an edge is checked against graph rules. For example, the shape of the graph could be checked, e.g., if the rules require an acyclic graph, is the graph an acyclic graph? If the graph fails this constraint check (648—Fail) then the proposed edge is removed and processing proceeds to block 652, which specifies a general error message for additions and deletions. If the proposed edge satisfies the graph rules (648—Pass), a success message may be supplied 650. Subsequently, the update request is modified 654. For example, the request is removed from the component object's metadata. The operations needed to delete an edge are the same as addition described above except that in operation 646 an entry is removed from the table.

A set of optional operations 660 for using relationships and graphs is shown in FIG. 6C. In operation 662, a plurality of relationship objects defining the relationship between a first component object and a second component object are loaded in to or defined in a computer, e.g., system 500. The plurality of relationship objects define how a connection between the first and second component objects is constructed or maintained. The plurality of relationship objects could have been created as operations in the set of operations 600. In operation 664, an edge as defined by a relation loaded or defined in operation 662 is added or deleted. In operation 666 a first data structure associating component objects is queried. For example a table storing the component object ID for a third component object, e.g., a relationship object, defining the relationship between the first component object and the second component object may be queried. A query could comprise, find a component object with a specific component object ID, a child or parent of a component object, etc. The query could dynamically generate edge data from the entries in the first data structure. In operation 668, a component object is acted upon subject to the set of rules loaded in operation 662. For example the first component object is modified. Another example is the first component object is deleted. Yet another example is both the first component object and the third component object are deleted.

FIGS. 7A and 7B illustrate relationships in accordance with embodiments of the invention. These object relationships are provided for the purposes of illustration. In FIG. 7A a hierarchy of user and user groups is shown. The users Gianni 712, Ivan 714, and Jean 716 belong to either or both of the user group managers 702 and sales 704. The graph 700 is an example of a directed acyclic graph. The relationship between the users and users groups is defined in a relationship object (not shown) in accordance with embodiments of the present invention. The edges of graph 700 are stored in a data structure in accordance with embodiments of the present invention. In FIG. 7B a hierarchy of databases, metadata layers, and documents is shown. The databases 766 and 768 are connected to metadata layers, e.g., universes, and documents, e.g., reports. A set of universes, as examples of metadata layers, are shown, including a sales and marketing universe 770, a warehouse inventory universe 772, and a store inventory universe 774. The databases may also be attached to a document directly, e.g., report 752. The universes are connected to reports 754, 756, 758 and 760. As shown in FIG. 7B a report may be connected to more than one universe. The graph 750 is acyclic because no cycle returns to its starting point. The graph 750 is not a tree because the Full Inventory Report Q3 has two parents—the Warehouse Inventory Report 772 and the Store Inventory Report 774. The relationships between the databases, metadata layers, and documents are stored in component objects in accordance with an embodiment of the present invention.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable memory, comprising:
a table with a plurality of rows and a plurality of columns, including:
a first entry in a first row storing a first component object ID for a parent component object,
a second entry in the first row storing a second component object ID for a child component object, and
a third entry in the first row storing a third component object ID for a relationship object defining the relationship between the parent component object and the child component object, wherein the first row defines an edge in a graph; and
a set including:
the parent component object,
the child component object, and
the relationship object, wherein the parent component object and the child component object are objects in a business intelligence system.

2. The computer readable memory of claim 1 wherein the child component object and parent component object are selected from at least one of a user and a user group, a document and a category, a universe and a data connection, a category and a universe, and a server and a server group.

3. The computer readable memory of claim 1 wherein the table forms a portion of a cube.

4. The computer readable memory of claim 1 wherein the set includes a plurality of component objects, and each component object in the plurality of component objects is unique.

5. The computer readable memory of claim 4 wherein the plurality of component objects includes at least one component object and at least one relationship object.

6. The computer readable memory of claim 1 wherein the table includes a second row, the first row and the second row defining a tree.

7. The computer readable memory of claim 1 wherein the relationship object includes metadata.

8. The computer readable memory of claim 7 wherein the metadata is divided into a plurality of properties.

9. The computer readable memory of claim 8 wherein a property of the plurality of properties is contained in a property bag.

10. The computer readable memory of claim 7 wherein the metadata encodes rules for the relationship between the parent component object and the child component object defined by the relationship object.

11. The computer readable memory of claim 7 wherein the metadata encodes rules for a graph.

12. The computer readable memory of claim 1 further comprising instructions to encode rules for the relationship between the parent component object and the child component object defined by the relationship object.

13. The computer readable memory of claim 1 further comprising instructions to encode rules for a graph.

14. The computer readable memory of claim 1 further comprising a set of rules constraining the relationship between the parent component object and the child component object defined by the relationship object and constraining the form of a graph.

15. The computer readable memory of claim 14 wherein the set of rules includes a set of graph characteristic rules.

16. The computer readable memory of claim 15 wherein the set of graph characteristic rules controls the shape and behavior of the graph.

17. The computer readable memory of claim 15 wherein the set of graph characteristic rules controls how deletes are cascaded through the graph.

18. The computer readable memory of claim 14 wherein the set of rules includes a set of graph constraint rules.

19. The computer readable memory of claim 18 wherein the set of graph constraint rules controls which objects are allowed in the graph.

20. The computer readable memory of claim 18 wherein the set of graph constraint rules controls how the first data structure is modified.

21. The computer readable memory of claim 14 wherein the set of rules includes a set of graph security rules.

22. The computer readable memory of claim 14 wherein the set of rules includes a set of graph edge copy rules.
